(19) United States
(12) Patent Application Publication
(10) Pub. No.: US 2017/0352935 A1
(43) Pub. Date: Dec. 7, 2017

(54) Lithium Accumulator With A Two-Layered Thermally Insulating Package And With A Heat Pipe For Thermal Management

(71) Applicant: COMMISSARIAT A L'ENERGIE ATOMIQUE ET AUX ENERGIES ALTERNATIVES, Paris (FR)

(72) Inventors: Fabien Perdu, Saint Martin Le Vinoux (FR); Lionel Picard, Seyssinet-Pariset (FR)

(21) Appl. No.: 15/536,397

(22) PCT Filed: Dec. 16, 2015
(86) PCT No.: PCT/EP2015/079976

§ 371 Date: Jun. 15, 2017

(30) Foreign Application Priority Data
Dec. 16, 2014 (FR) 1462536

(51) Int. Cl. H01M 10/6552; H01M 10/6556; H01M 2/02; H01M 10/654; H01M 10/052

(52) U.S. Cl. CPC H01M 10/6552; H01M 2/0277; H01M 2/0287; H01M 10/654; H01M 2/0272; H01M 10/6556; H01M 10/052

(57) ABSTRACT

Lithium electrochemical accumulator including at least one first package housing at least one electrochemical cell, said first package including at least: one internal thermally insulating layer suitable for confining, to the interior of a first package, the heat given off even in case of abnormal operation of a cell C and for protecting the cell(s) from heat generated outside the first package; one external layer superposed on the internal layer, the external layer being mechanically strong and fire resistant; and one cooling device including at least one heat pipe the enclosure of which passes through the first package(s) in a seal-tight manner and such that the heated zone of the heat pipe(s) is located inside the first package(s) and that the cooled zone of the heat pipe(s) is located outside the first package(s).

### TECHNICAL FIELD

The present invention relates to the field of lithium electrochemical generators, which operate according to the principle of insertion or deinsertion, or in other words intercalation-deintercalation, of lithium in at least one electrode.

The invention in particular relates to a lithium and in particular to a lithium-ion electrochemical accumulator, the package of which is mechanically strong, fire resistant and thermally insulating, and the thermal management of which is ensured via a heat pipe, both in normal operation and in case of abnormal operation of the electrochemical cell(s) of the accumulator.

### PRIOR ART

A lithium accumulator or battery usually comprises one or more electrochemical cells each consisting of a constituent electrolyte between a positive electrode or cathode and a negative electrode or anode, a current collector connected to the cathode, a current collector connected to the anode and, lastly, a package arranged to contain the electrochemical cell(s) with seal-tightness while being passed through by a portion of the current collectors.

The first function of a package is to separate the interior of the accumulator from the exterior. The electrolyte of an electrochemical cell must never make contact with traces of moisture, at the risk of producing hydrofluoric acid and greatly degrading the performance of the cell.

A package must also resist high mechanical stresses originating either from the exterior (shocks, vibrations) or from the interior (pressure in case of failure of the electrochemical cell).

A package also has thermal protection functions: it must allow the battery to resist for a sufficient time an exterior fire. Moreover, it is necessary to ensure that thermal runaway of a cell cannot propagate to the neighboring cells, or from a module containing a plurality of cells to the neighboring modules.

All of these safety constraints make it necessary to design a package that is as solid as possible, as seal-tight as possible, and as thermally insulating as possible, while taking care not to penalize the mass and volume of the accumulator.

Furthermore, optimal operation of the cells in terms of power and ageing requires a precise thermal management: thus, if the temperature inside the package is too high, the cell(s) age(s) prematurely even if it/they is/are not stressed in operation. In contrast, if the temperature inside the package is too low, the cell(s) is (are) incapable of delivering power because the electrical resistance is excessive and it (they) rapidly degrade under load because of the deposition of lithium metal on the negative electrode.

Moreover, the cell(s) give off in normal operation heat that must be removed from the package, in order to avoid an excessive temperature in the interior of the package.

Many solutions have been imagined for removing heat from inside the package in order to prevent heating of a (more than one) cell(s) in normal operation.

Existing accumulator packages are most often metal and rigid or, flexible and take the form of laminated layers. Existing packages for modules and battery packs containing a plurality of modules are most often metal and rigid. In all these cases, the packages are thermally conductive, this being favorable in terms of operating conditions but unfavorable in terms of safety in case of abnormal operation of the cell(s).

As regards the cooling of the electrochemical cells, they may be cooled either by an airflow or by a liquid cooling circuit, and sometimes by heat pipes. A heat pipe consists of a seal-tight enclosure enclosing a heat-transfer fluid that absorbs the heat by vaporizing in a zone called the hot zone or evaporator, and releases it by condensing in another zone called the cooled zone or condenser. A heat pipe makes it possible to exchange passively heat fluxes two orders of magnitude higher than the best metals in the same geometry. The reader may refer to publication [1].

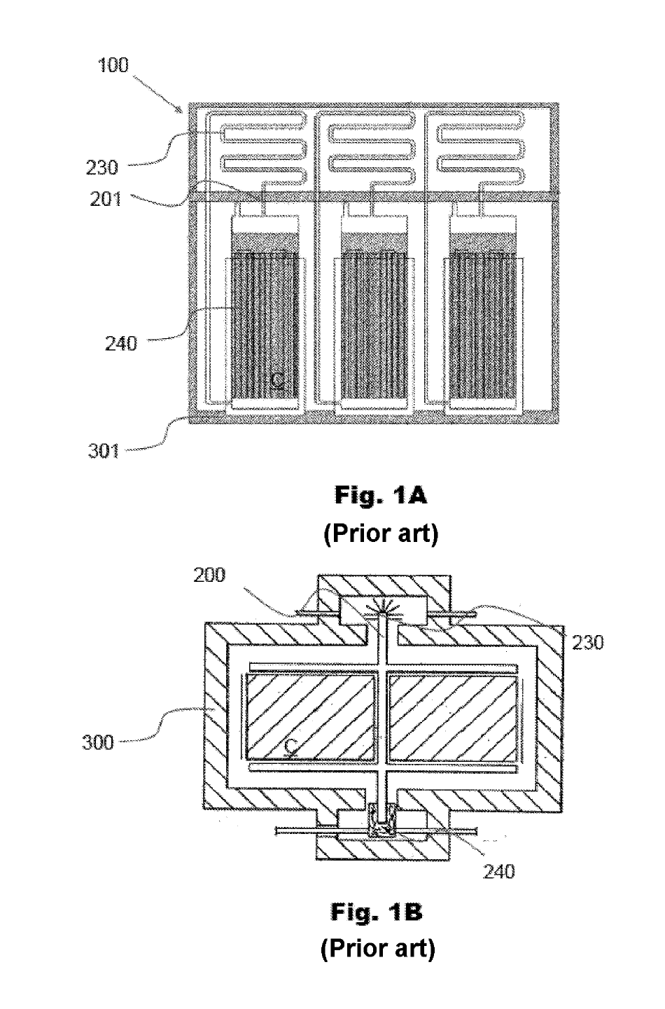

Among existing solutions that propose heat pipes for effectively removing heat from a battery, mention may be made of patent application CN103367837 A. A battery 100 according to this patent application has been reproduced in FIG. 1A using new reference numbers. This battery 100, comprises a casing and a plurality of electrochemical cells C arranged in the lower compartment 301 of the casing. The electrochemical cells are cooled by pulsating heat pipes 201 and make contact with the heated zone 240 of the heat pipes. The cooled zone 230 of these pulsating heat pipes 201 is located in the upper casing compartment, which includes a phase-change material of high thermal inertia. Furthermore, the upper casing compartment is connected to a heatsink (not shown).

Patent application FR2989323 A1 describes for its part a battery module including cells arranged in a compartment, the cells making direct contact with heat pipes operating via capillary action. The cooled zone of each heat pipe is integrated into a matrix of phase change material. The phase change material makes contact with a heatsink.

Patent application US 2011/0206965 A1 describes an accumulator comprising a plurality of electrochemical cells and heat pipes individually inserted between two cells, the cells and heat pipes all being arranged in the same casing. The cooled zone of each heat pipe is equipped with fins allowing the cooling to be improved and the uniformity of the temperature in the interior of the casing to be increased.

Patent application US 2011/0000241 A1 describes for its part an accumulator comprising a plurality of electrochemical cells and an associated heat pipe, which are arranged in the same casing, the cooled zone of the heat pipe being connected to an active cooling device that is a heat exchanger.

These prior-art patent applications provide solutions to the underlying problems of thermal management of accumulators in normal operation but do not provide effective protection against excessive heat generated outside a package.

Thus, it will be understood that all the known solutions, which promote interior/exterior heat exchange, are antinomic to the desire to obtain protection from fire, extreme temperatures, or the propagation of cell thermal runaway. In contrast, the use of materials that provide excellent insulation from fire, extreme temperatures or the propagation of runaway makes operation in terms of power and battery lifetime more difficult because the heat inside the package becomes more difficult to remove.

Patent application FR 2 539 919 describes a battery 100, reproduced in FIG. 1B, comprising a plurality of electrochemical cells C arranged in the interior of a thermally protective jacket 300 and a heat pipe 200. The heated zone 240 of the heat pipe is located in the interior of the jacket 300 and is heated by a catalytic converter. However, in the disclosed configuration, the heat pipe supplies heat from the exterior to the electrochemical cells C, which in this case use sodium tetrachloroaluminate (NaAlCl₄) as the electrolyte and which require high operating temperatures, typically between 300° C. and 400° C. In other words, the disclosed heat pipe 200 only has the function of heating the electrochemical cells and is not provided to remove heat from inside the package. Potassium is used as heat-transfer fluid, and this potassium condenses level with the cooled zone 230. Thus, FR 2 539 919 in no case discloses a system for cooling electrochemical cells. Nothing in this patent application relates to the thermal management of a lithium accumulator, which differs from that of an NaAlCl₄ accumulator since it is necessary to supply it with heat and not to cool it in operation.

Thus, there is a need to improve lithium batteries and accumulators, in particular in order to ensure both a better thermal and mechanical protection of the electrochemical cell(s) and the most effective possible thermal management of the latter, even in case of excessive heat in the interior and/or on the exterior of the package that houses it (them).

The aim of the invention is to at least partially meet this need.

### SUMMARY OF THE INVENTION

To do this, the subject of the invention under one of its aspects is a lithium electrochemical accumulator including at least one first package housing at least one electrochemical cell, said first package including at least:
one thermally insulating internal layer that is suitable for confining to the interior of a first package the heat given off even in case of abnormal operation of a cell C and for protecting the cell(s) from heat generated outside the first package,
one external layer that is superposed on the internal layer, the external layer being mechanically strong and fire resistant,

and
one cooling device including at least one heat pipe the enclosure of which passes through the first package(s) in a seal-tight manner and such that the heated zone of the heat pipe(s) is located in the interior of the first package(s) and such that the cooled zone of the heat pipe(s) is located on the exterior of the first package(s).

The expression “heated zone of a heat pipe” is understood, in the present invention, to have its usual technological meaning, namely the zone of the heat pipe in which the heat-transfer liquid of the heat pipe receives heat and evaporates. The heated zone is also usually called the evaporator.

The expression “cooled zone of a heat pipe” is understood, in the present invention, to also have its usual technological meaning, namely the zone of the heat pipe in which the heat-transfer liquid of the heat pipe transmits heat and condenses. The cooled zone is also usually called the condenser. For more details, the reader may in particular refer to publication [1].

The accumulator according to the invention may house one or more electrochemical cells in a first package. A package according to the invention has two functions: a mechanical-protection and fire-resistance function, and a thermal-insulation function. The thermal insulation must be sufficient to protect the electrochemical cell(s) from extreme exterior temperatures, which may in particular be caused by the abnormal operation of a neighboring electrochemical cell located outside the package.

The expression “abnormal operation” is understood to mean an increase in temperature and pressure above that expected in normal operation and which is sufficiently large to cause degradation of the cell in question and/or thermal runaway in (a) nearby cell(s).

Thus, the cooling device is suitable for removing heat confined by the internal layer inside the accumulator even in case of abnormal operation of the electrochemical cell.

The thermal management of the accumulator in normal or abnormal operation is therefore ensured by the cooling device.

Typically, a heat pipe implemented in the invention comprises the following elements:
a tubular jacket made of aluminum, (mild, stainless, etc.) steel, copper, etc.
a fluid that is diphase, in the interior of the tubular jacket, at the temperature of use, such as for example water, ammonia, methanol, ethanol, acetone, toluene, heptane, etc.
where appropriate, a porous capillary medium such as a web or a sintered metal powder, or grooves in the interior of the tubular jacket.

Care is taken to ensure that the association of the diphase fluid and the material of the jacket respects constraints mainly related to corrosion.

Advantageously, the diameter of the heat pipe according to the invention is about a few millimeters and preferably comprised between 1 mm and 2 cm and more preferably between 2 and 6 mm. The heat pipe may be any length, since its length has only a very small effect on the heat removal. For example, the heat pipe may protrude from the package by 1 mm to 2 cm.

According to one advantageous variant, the thermal conductivity K of the internal layer is lower than 0.05 W·m⁻¹·K⁻¹. An internal layer with a very low thermal conductivity allows heat generated inside the package according to the invention, in case of abnormal operation of an electrochemical cell, to be confined with high effectiveness or an electrochemical cell to be protected from heat generated outside the package.

According to another advantageous variant, the external layer provides a fire resistance according to standard SAE J2464.

According to another advantageous variant, the Young's modulus E of the protective external layer is higher than 1 GPa.

According to one advantageous embodiment, the cooled zone of the heat pipe is located above the first package, the heat pipe thus forming a gravity-assisted heat pipe or thermosiphon. It will be noted that in the context of the invention, the expression “two-phase thermosiphon” is understood to have the usual sense known to those skilled in the art, such as defined in publication [1]. Thus, a two-phase thermosiphon is a heat pipe that allows heat to be transferred by evaporation/condensation of a fluid in the interior of a jacket with no capillary structure, i.e. with a return of condensates by gravity in the interior of the jacket.

A gravity-assisted heat pipe [1] is a heat pipe in which there is a capillary structure, generally grooves, but the return of the condensates from the condenser to the evaporator is ensured by gravity, the evaporator of the heat pipe being in a lower position than the condenser. The aim of the capillary structure is therefore not to return the condensates; but to improve the evaporation and condensation transfer coefficients, and to delay the onset of the entrainment limit.

According to one advantageous variant of the invention, at least one heat pipe forms a current output terminal of the accumulator. This advantageously makes it possible to do away with a step of welding an output terminal to a portion of the accumulator, as in the accumulators according to the prior art.

According to one embodiment, the heat pipe(s) is (are) suitable for limiting or even suppressing the liquid phase within its (their) enclosure in case of abnormal operation of the electrochemical cell(s) from which it (they) receives (receive) heat level with its (their) heated zone.

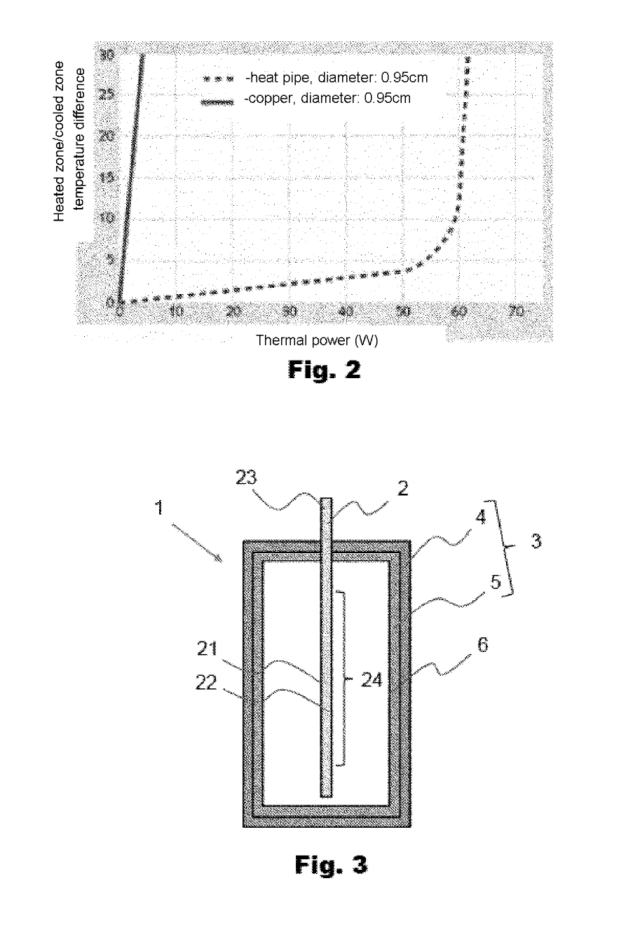

A heat pipe configured in such a way exhibits a saturation effect as illustrated in FIG. 2: when the temperature becomes too high, the heat pipe is dimensioned such that the liquid phase completely evaporates.

Thus, the amount of heat transmitted by the heated zone to the cooled zone of the heat pipe reaches a maximum that no longer significantly grows beyond the saturation temperature, which is chosen to be the abnormal operating temperature of an electrochemical cell. The excessive heat is thus completely confined by the package and by the heat pipe.

According to one variant embodiment of the internal layer, the latter comprises a matrix made of thermosetting or thermoplastic polymer, this matrix being mainly filled with silica aerogel or some other particulate filler.

The material forming the matrix of the internal layer is preferably chosen from urethane, acrylate, methacrylate, polyether and silicone, or is a vinyl and in particular styrene polymer, an optionally cross-linked polyolefin polymer, an unsaturated polyester type polymer or an epoxy resin.

According to one variant of the protective external layer, the latter comprises a thermoset matrix in which a fibrous reinforcement is embedded.

The material forming the matrix of the external layer may advantageously be chosen from urethane, acrylate, methacrylate, or be a vinyl and in particular styrene polymer, an unsaturated polyester type polymer or an epoxy resin.

The material forming the fibrous reinforcement may advantageously be short- or long-fiber and preferably fibers of glass, of carbon, an aromatic polyamide, of silicon carbide SiC, fibers of bamboo, of linen, fibers of coconut or hemp.

The enclosure(s) of the heat pipe(s) may be of prismatic or circular cross section. A heat pipe with such an enclosure cross section may optionally be adapted to serve thus as a spool for rolling a cell.

According to one preferred embodiment, the electrochemical cell C takes the form of a roll rolled around the enclosure of the heat pipe.

According to another embodiment, the enclosure of at least one heat pipe is arranged on the periphery of the electrochemical cell(s) C in an interstice in the interior of the first package.

According to a first embodiment, the electrochemical accumulator includes a plurality of a number of n first packages, a number equal to n−1 of the first packages of which each houses an electrochemical cell, the (n−1) first packages themselves being housed in the interior of the other first package.

According to a second embodiment, the accumulator includes a second package based on a metal alloy, such as an aluminum alloy, housing the electrochemical cell(s), the second package itself being housed in a seal-tight manner in the first package. It is possible according to this embodiment to implement the invention in accumulators employing one or more metal-alloy packages according to the prior art.

According to this second embodiment, the first package includes, on the internal layer, an electrically conductive coating. The electrically conductive coating may preferably be based on metal particles sintered by photonic sintering or graphite conductors, said coating preferably being deposited in the form of a paint or aerosol. Its role is to ensure the electromagnetic compatibility of the battery.

According to one variant embodiment, the first package includes on its internal face, a coating having a barrier function, said coating being suitable for ensuring the chemical neutrality of the internal layer with respect to the electrolyte of the electrochemical cell C.

The material of the barrier coating may be chosen from polypropylene, polyethylene, a polymer from the family of the polyaryletherketones (PAEK), preferably polyetheretherketone (PEEK™), or a polymer from the family of the polyimides.

### DETAILED DESCRIPTION

Other advantages and features will become more clearly apparent on reading the detailed description, which is given with reference to the following figures, in which:

FIG. 1A shows a lithium-ion accumulator with a cooling device according to the prior art,

FIG. 1B shows an NaAlCl₄ accumulator according to the prior art,

FIG. 2 illustrates the effect of saturation of a heat pipe,

FIG. 3 illustrates a schematic view of the relative arrangement between the package in which an electrochemical cell is housed and a heat pipe of a lithium-ion accumulator according to the invention,

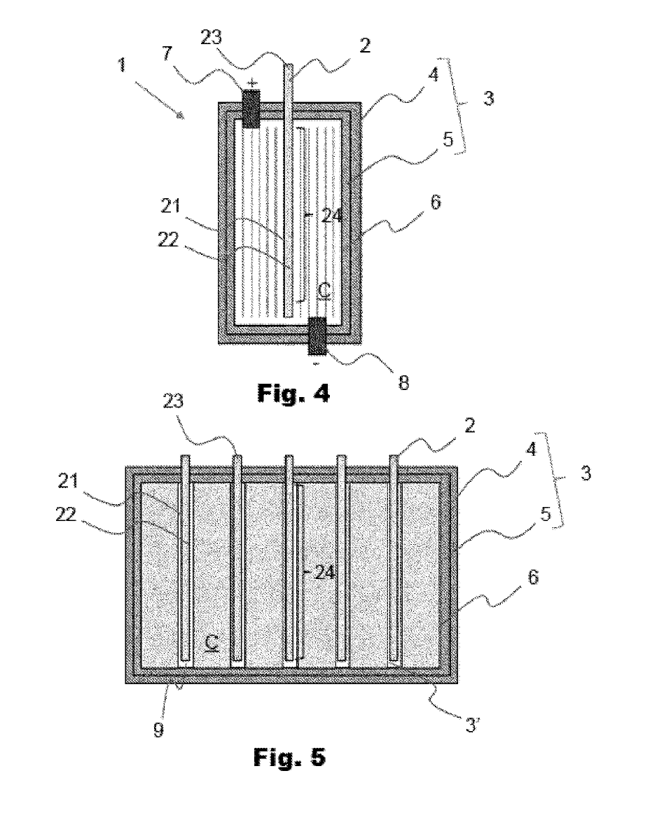

FIG. 4 illustrates an exemplary embodiment of a lithium-ion accumulator according to the invention,

FIG. 5 illustrates another exemplary embodiment of a lithium-ion accumulator according to the invention,

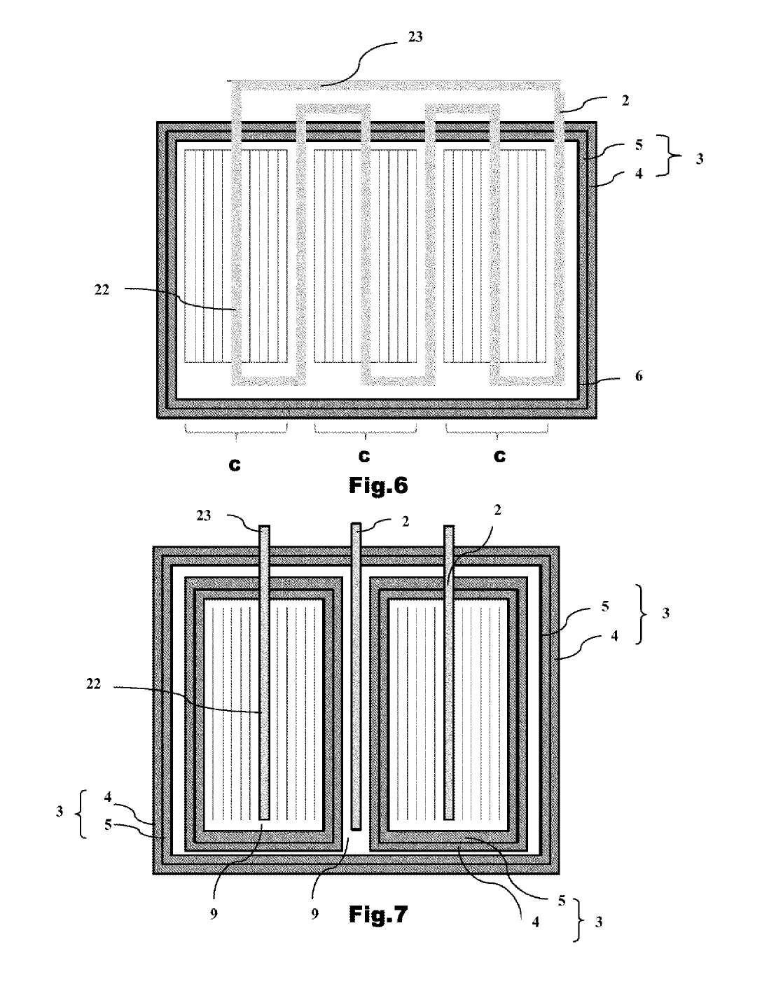

FIG. 6 also illustrates another exemplary embodiment of a lithium-ion accumulator according to the invention,

FIG. 7 also illustrates another exemplary embodiment of a lithium-ion accumulator according to the invention.

FIGS. 1A to 2 have already been described in detail in the preamble. They are therefore not discussed below.

As FIG. 3 shows, the accumulator 1 according to the invention comprises a package 3 that houses a least one lithium electrochemical cell.

The package 3 includes an external layer 4 that is superposed on a thermally insulating internal layer 5.

The external layer 4 is mechanically strong and provides fire resistance. The external layer 4 is preferably made of a polymer such as an epoxy resin, polyurethane resin, polyvinyl resin or a polyester resin, where appropriate reinforced with a glass-fiber or carbon-fiber type reinforcement. The thickness of the layer 4 is preferably comprised between 300 μm and 2 mm and more preferably is about 1 mm.

The internal layer 5 is preferably made of polyethylene (PE) or of polypropylene (PP), or of PTFE or PFE, and optionally contains thermally insulating fillers such as nanoclay or alumina fillers for example. The thickness of the layer 5 is preferably smaller than 300 μm and larger than 20 nanometers (nm).

A coating 6 covers the internal layer 5. This coating 6 may have various functions as explained below.

The cooling device of the accumulator 1 comprises a heat pipe 2 including a seal-tight enclosure 21, in the interior of which a heat-transfer fluid 22 flows. This heat-transfer fluid is suitable for operating in linear regime at the operating temperature of a lithium electrochemical cell, and may typically be water.

The heat pipe 2 passes through the package 3 in a seal-tight manner. The heated zone 24 is located within the package 3. The cooled zone 23 is located on the exterior of the package 3.

Typically, the diameter of the heat pipe 2 is about a few millimeters and preferably comprised between 1 mm and 2 cm and more preferably between 2 and 6 mm. The heat pipe may be any length, since its length has very little effect on the heat removal. For example, the heat pipe may protrude from the package by 1 mm to 2 cm.

One exemplary embodiment of the invention is shown in FIG. 4. In this example, a single electrochemical cell C is arranged in the interior of the first package 3. The electrochemical cell takes the form of a roll rolled around the heat pipe 2. The enclosure 21 of the heat pipe 2 has a circular cross section. The positive terminal 7 and negative terminal 8 also pass through the package 3 in a seal-tight manner. According to one variant, it is possible to use the heat pipe itself as an output terminal for the current of the accumulator.

The coating 6 for its part ensures the neutrality of the internal layer 5 with respect to the electrolyte of the electrochemical cell C.

Since the first package 3 is very thermally insulating, the internal layer 5 having a thermal conductivity lower than 0.05 W·m⁻¹·K⁻¹, thermal management in normal operation of the cell 6 is ensured via the heat pipe 2.

The heated zone 24 is located in the interior of the hollow cylinder formed by the cell C rolled about itself, and makes thermal contact with the latter. Thus, a large amount of heat is transmitted from the cell C to the heated zone 24. The heat-transfer fluid 22 then follows a cycle of evaporation and condensation: it evaporates in the heated zone 24, and condenses in the cooled zone 23. This cooled zone 23 may optionally include a heat spreader in order to remove the heat transmitted during the condensation of the fluid 22.

In this example, the heated zone 24 being located below the zone 23, the heat pipe 2 forms a thermosiphon and functions by virtue of gravity: the condensed fluid falls under gravity toward the heated zone 23 where it begins a new cycle of evaporation and condensation.

In case of abnormal operation of the cell C, the internal layer 5 confines the heat to the interior of the package 3. In addition, a heat pipe has a saturation limit as shown in FIG. 5. Beyond a certain temperature, it ceases to transmit heat. Thus, in case of abnormal operation of the cell C, the heat is no longer transmitted by the heat pipe 2. Heat is thus effectively confined to the interior of the package 3 according to the invention.

Furthermore, in case of high temperature outside the package 3, the internal layer 5 prevents the degradation of the electrochemical cell C, or in other words protects the electrochemical accumulator 1.

The accumulator illustrated in FIG. 3 is produced by rolling the electrochemical cell C around the enclosure of the heat pipe 2. The enclosure 21 of the heat pipe 2 is thus suitable for serving as a spool during the manufacture of the cell.

To produce the various layers 4, 5 of the package, various manufacturing processes may be envisioned. Thus, an injection molding process may be advantageous for producing the thermally insulating layer 5, from a thermoplastic polymer and a low-K filler.

Processes conventionally used to form composites such as reaction injection molding, the various injection molding techniques that employ sheet molding compounds (SMCs) or bulk molding compounds (BMCs), resin transfer molding (RTM) and contact molding may be used to form an external layer 4 made of thermosetting polymer.

A bi-material thermoplastic-thermoset injection molding process is envisionable for the production in a single step of the two layers 4, 5 of the package. Advantageously, the positive terminal 7 and negative terminal 8 may already be present at the start of the injection molding process. It is also possible to envision producing the layers 4, 5 using the injection molding process described and claimed in patent application FR 14 51546 in the name of the applicant.

An exemplary embodiment of the package layers 4, 5 comprising a fiber-reinforced matrix will now be described.

This example consists in creating two shell halves that will be closed around the electrochemical cell C. The electrolyte is introduced at the moment of closure of the two shell halves by injection before final adhesive bonding/plastic welding.

This example with fiber-reinforced matrices may be produced by injection molding a filled thermoplastic using an RTM technology. Thus, the following steps are carried out in succession:

1—various thicknesses of glass fiber cloth are introduced with the connection terminals 7, 8 into a preheated RTM mold;

2—the mold is closed and placed under vacuum;

3—precursors of the epoxide resin are injected into the mold, this leading to impregnation of the fibers;

4—the epoxide resin is baked for the recommended time at the recommended temperature;

5—the temperature of the mold is set for the injection of thermoplastic;

6—the valve in the mold is opened to define the molding zone of the thermal reinforcement of the electrochemical cell;

7—polyethylene (PE) highly filled with micron-sized particles of thermally insulating materials is injected;

8—the object formed is extracted from the mold and excess material is trimmed/degated;

9—two shell halves are closed around the electrochemical cell C rolled around its heat pipe 2 with thermoplastic welding around two needles, one of the needles being used to create a vacuum and the other of the needles being used simultaneously to inject the electrolyte;

10—the needles are removed while completing the thermoplastic weld;

11—thermoset is adhesively bonded to the thermosetting zones in order to ensure reinforcement uniformity for the fire resistance and mechanical reinforcement.

Another exemplary embodiment of the invention is illustrated in FIG. 5. According to this example, the accumulator 1 comprises a plurality of electrochemical cells C. Each electrochemical cell is arranged in a seal-tight manner within a package 3′ according to the prior art. This package 3′ is made of a metal alloy, such as an aluminum alloy, or of plastic. This package 3′ according to the prior art is housed in a seal-tight manner in the package 3 according to the invention. A plurality of heat pipes 2 pass, in a seal-tight manner, through the package 3 and have one of their ends arranged in interstices 9 within the package 3. Their heated zones 24 are thus located in contact with the packages 3′ according to the prior art, which are thermally conductive and which therefore spread the heat liberated by the electrochemical cells C. The thermal contact between a heated zone 24 of the heat pipe and the package 3′ of an electrochemical cell may be improved by interposing thermally conductive grease.

Preferably, in this example, an electrically conductive coating 6 covers the interior of the internal layer 5 of the package 3, in order to ensure the electromagnetic compatibility of the battery.

In case of abnormal operation of a cell C, the internal layer 5 confines heat to the interior of the package 3. Likewise, in case of a high temperature outside the package 3, the internal layer 5 prevents degradation of the electrochemical cells C and thus protects the electrochemical accumulator 1.

Other variants and improvements may be envisioned without however departing from the scope of the invention.

For example, an embodiment may be envisioned in which the accumulator comprises a plurality of electrochemical cells C submerged in the same electrolyte in a package 3 according to the invention. Such an embodiment is illustrated in FIG. 6, which shows three cells arranged in parallel in the same package 3, with a single pulsation heat pipe 2, the heated zones 24 of which are in the interior and the cooled zones 23 of which are on the exterior. This embodiment is particularly advantageous when it is desired to produce cells C of very high capacity.

It is also possible to envision a “dual package” embodiment in which the electrochemical accumulator includes a plurality of a number of n first packages, a number equal to n−1 of the first packages of which each houses an electrochemical cell C, the (n−1) first packages themselves being housed in the interior of the other first package. This embodiment is illustrated in FIG. 7, which shows two cells arranged in parallel and each in the interior of a package 3 according to the invention, a central heat pipe 2 being arranged between these two packages 3 that are themselves housed in a third peripheral package 3.

### CITED REFERENCE

[1]: Bonjour J, Lefevre F, Sartre V, Bertin Y, Romestant C, Ayel V and Platel V, “Systèmes Diphasiques De Contrôle Thermique—Thermosiphons Et Caloducs”, Techniques de l'ingénieur, Vol. BE9545, 2011.

1. A lithium electrochemical accumulator, including:
at least one first package housing at least one electrochemical cell, said first package including at least one thermally insulating internal layer that is suitable for confining to the interior of the first package the heat given off even in case of abnormal operation of a cell C and for protecting the cell(s) from heat generated outside the first package,
one external layer that is superposed on the internal layer, the external layer being mechanically strong and fire resistant,
and
one cooling device including at least one heat pipe the enclosure of which passes through the first package(s) in a seal-tight manner and such that the heated zone of the heat pipe is located in the interior of the first package(s) and such that the cooled zone of the heat pipe is located on the exterior of the first package(s).

2. The electrochemical accumulator as claimed in claim 1, the thermal conductivity K of the internal layer being lower than 0.05 W·m⁻¹·K⁻¹.

3. The electrochemical accumulator as claimed in claim 1, the Young's modulus E of the external layer being higher than 1 GPa.

4. The electrochemical accumulator as claimed in claim 1, the cooled zone of the heat pipe being located above the first package, the heat pipe thus forming a gravity-assisted heat pipe or thermosiphon.

5. The electrochemical accumulator as claimed in claim 1, at least one heat pipe forming an output terminal for the current of the accumulator.

6. The electrochemical accumulator as claimed in claim 1 the heat pipe(s) being suitable for limiting or even suppressing the liquid phase within its (their) enclosure in case of abnormal operation of the electrochemical cell(s).

7. The electrochemical accumulator as claimed in claim 1, the internal layer comprising a matrix made of thermosetting or thermoplastic polymer, this matrix being mainly filled with silica aerogel or some other particulate filler.

8. The electrochemical accumulator as claimed in claim 7, the material forming the matrix of the internal layer being chosen from urethane, acrylate, methacrylate, polyether and silicone, or being a vinyl and in particular styrene polymer, an optionally cross-linked polyolefin polymer, an unsaturated polyester type polymer or an epoxy resin.

9. The electrochemical accumulator as claimed in claim 1, the external layer comprising a thermoset matrix in which a fibrous reinforcement is embedded.

10. The electrochemical accumulator as claimed in claim 9, the material forming the matrix of the external layer being chosen from urethane, acrylate, methacrylate, or being a vinyl and in particular styrene polymer, an unsaturated polyester type polymer or an epoxy resin.

11. The electrochemical accumulator as claimed in claim 9, the material forming the fibrous reinforcement being short- or long-fiber and preferably fibers of glass, of carbon, an aromatic polyamide, of silicon carbide SiC, fibers of bamboo, of linen, fibers of coconut or hemp.

12. The electrochemical accumulator as claimed in claim 1, the enclosure(s) of the heat pipe(s) being of prismatic or circular cross section.

13. The electrochemical accumulator as claimed in claim 1, the electrochemical cell C taking the form of a roll rolled around the enclosure of the heat pipe.

14. The electrochemical accumulator as claimed in claim 1, the enclosure being arranged on the periphery of the electrochemical cell(s) C in an interstice in the interior of the first package.

15. The electrochemical accumulator as claimed in claim 1, including a plurality of a number of n first packages, a number equal to n−1 of the first packages of which each houses an electrochemical cell, the (n−1) first packages themselves being housed in the interior of the other first package.

16. The electrochemical accumulator as claimed in claim 1, including at least one second package based on a metal alloy, such as an aluminum alloy, housing the electrochemical cell(s), the second package itself being housed in a seal-tight manner in the first package.

17. The electrochemical accumulator as claimed in claim 16, the first package including, on the internal layer, an electrically conductive coating.

18. The electrochemical accumulator as claimed in claim 17, the electrically conductive coating being based on metal particles sintered by photonic sintering or graphite conductors, said coating preferably being deposited in the form of a paint or aerosol.

19. The electrochemical accumulator as claimed in claim 1, the first package including on the internal layer a coating having a barrier function, said coating being suitable for ensuring the chemical neutrality of the internal layer with respect to the electrolyte of the electrochemical cell C.

20. The electrochemical accumulator as claimed in claim 19, the material of the barrier coating being chosen from polypropylene, polyethylene, a polymer from the family of the polyaryletherketones (PAEK), preferably polyetheretherketone (PEEK™), or a polymer from the family of the polyimides.
